(19) United States
(12) Patent Application Publication
(10) Pub. No.: US 2022/0274392 A1
(43) Pub. Date: Sep. 1, 2022

(54) LAMINATE METHODS AND PRODUCTS

(71) Applicant: Danapak Flexibles A/S, Slagelse (DK)

(72) Inventors: Torben Fogtmann, Slagelse (DK); Peter Johansen, Slagelse (DK); Lars Christensen, Slagelse (DK)

(21) Appl. No.: 17/621,591

(22) PCT Filed: Jul. 10, 2020
(86) PCT No.: PCT/DK2020/050212

§ 371 Date: Dec. 21, 2021

(30) Foreign Application Priority Data
Jul. 11, 2019 (EP) 19185793.7
Apr. 22, 2020 (DK) PA202070248

(51) Int. Cl. B32B 37/12; B32B 7/12; B32B 15/088; B32B 38/00; B32B 37/24

(52) U.S. Cl. CPC B32B 37/12; B32B 7/12; B32B 15/088; B32B 38/0008; B32B 37/24; B32B 2439/80; B32B 2307/732; B32B 2037/1269; B32B 2377/00; B32B 2310/14; B32B 2250/02; B32B 2255/26; B32B 2255/06

(57) ABSTRACT

The present disclosure relates to new laminate films whereby a contact layer is adhesive laminated to a base layer, such as a metal foil, or whereby a co-extrusion layer comprising a contact layer and at least one tie layer is adhered to a base layer, as well as uses of the laminate films to wrap APIs such as nicotine, fentanyl, lidocaine and rivastigmine, wherein the contact layer comprises COC, PA, EVOH, CBC, PVDF, COP, HDPE or EMAA.

### CROSS-REFERENCE TO RELATED APPLICATIONS

The present application is the national phase entry under 35 U.S.C. 371 of International Patent Application No. PCT/DK2020/050212 by Fogtmann et al., entitled “LAMINATE METHODS AND PRODUCTS,” filed Jul. 10, 2020, and claims priority to Danish Patent Application No. PA202070248 by Fogtmann et al., entitled “ADHESIVE LAMINATE METHODS AND PRODUCTS,” filed Apr. 22, 2020 and European Patent Application No. 19185793.7 by Fogtmann et al., entitled “ADHESIVE LAMINATE METHODS AND PRODUCTS,” filed Jul. 11, 2019, each of which is assigned to the assignee hereof, and each of which is expressly incorporated by reference in its entirety herein.

### TECHNICAL FIELD

The present disclosure relates to new laminate films whereby a contact layer is adhesive laminated to a base layer, such as a metal foil, or whereby a coextrusion layer comprising a contact layer and at least one tie layer is adhered to a base layer, as well as uses of the laminate films to wrap APIs such as nicotine, fentanyl, lidocaine and rivastigmine.

### BACKGROUND

In the pharmaceutical industry substances, including highly aggressive substances such as nicotine, fentanyl, rivastigmine and lidocaine are packed as tablets in inhalers, patches etc. resulting in special requirements for the packaging, laminate, or film for sealing these substances in order to ensure that no adverse degradation or uptake takes place.

The requirements of a packaging, film or laminate often include mechanically stable laminate that does not separate or deform; ensuring that the packaging is child proof to increase safety of potentially hazardous compounds; inert properties ensuring that chemical compounds do not migrate from the exterior environment of a laminate through the laminate and getting into contact with a sealed substance; and that the enclosed API does not react with the surface with which it is in contact or migrate through or into it.

A commercially used polymer that fulfils some or all of the requirements of extreme chemical resistance and inert properties is a polyactyllonitrile (PAN) based film, which is sold for example as resins under the trademark Barex®, which is manufactured i.a. by the company Ineos. Barex® is widely used and approved for drugs and food applications and is used because it is a good barrier towards oxygen, nitrogen and carbon dioxide compared to other common polymers, and because it has excellent chemical resistance towards different functional groups such as hydrocarbons, ketones, esters, alcohols, bases and acids and/or pharmaceuticals such as nicotine.

Furthermore, extruded Barex® resin is heat stable and therefore weldable at a temperature around 160-220° C., which makes it suitable for use in flexible packaging. However, Barex® is sold at a high price due to the difficulties in its production and subsequent extrusion to a film which results in a high loss of material. Furthermore, the water and oxygen resistance of Barex® is not satisfactory for all purposes.

Also, solutions are described in WO 2017/114922 to the present applicant, which discloses a laminate film having a co-extrusion or co-extrusion coated layer comprising a tie layer and a contact layer, said contact layer is the innermost layer facing an aggressive chemical pharmaceutical such as rivastigmine, nicotine, fentanyl or lidocaine. The contact layer may comprise polyamide, cyclic olefin copolymer, or an ethylene vinyl alcohol. The tie layer is co-extrusion coated to a base layer so that the tie layer is in contact with the base layer and the contact layer.

A further solution is described in WO 2015/123211 disclosing a film having a tie layer and a contact layer comprising COC and PE blends facing a pharmaceutical such as nicotine. The film may be produced by providing a co-extrusion layer or by adhesive lamination.

However, given the increased market and demands for flexible packaging, there is an instant need for finding various solutions and methods for producing strong durable laminates in a cost efficient manner with the same or improved properties as compared to prior art products.

### SUMMARY

With this background it is an object of the present disclosure to provide solutions that meet one or more of the needs described above, that is, i.a. solutions that provide impermeability and inertness to a packaging, while still providing a mechanically strong laminate that does not separate or deform, puncture, is sealable and otherwise resistant to mechanical impact and moreover solutions that provide alternative methods of producing such products with similar or improved properties.

One solution involves adhesive lamination. Adhesive lamination enables production at high speed as well as the ability to use to a wide variety of films and also allows for thin skins. Thus, adhesives lamination is less specialized than e.g. extrusion coating. This at the cost of higher capital costs. In addition, adhesive lamination provides for higher lamination strength and adhesive lamination provides for a good alternative to extrusion coating in providing new laminate films in other manners.

Accordingly, in a first aspect this is solved by providing a method for providing a laminate film, said method including i) providing a base layer, which is water and/or oxygen resistant; ii) providing a contact layer; and ii) laminating the base layer to the contact layer, (e.g., by adhesive lamination or extrusion lamination); wherein the contact layer comprises a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP) a high density polyethylene (HDPE), or an ethylene-methacrylic acid copolymer (EMAA).

In some examples, the contact layer consists of one substance which is a polymer selected from the group consisting of a cyclic olefin copolymer, a polyamide, an ethylene vinyl alcohol a cyclic block copolymer, a polyvinylidene fluoride, a cyclic olefin polymer, a high density polyethylene, or an ethylene-methacrylic acid copolymer and physical variations of thereof.

The contact later can be one or more layers. In some examples, the contact layer is a monolayer. In a particular example, the contact layer is a monolayer consisting of one substance.

The adhesive lamination can be performed either by solvent free or solvent based lamination. In some examples, the lamination is solvent based. In some examples, the solvent is ethyl acetate or methyl ethyl ketone, while other suitable solvents are contemplated and within the scope. The adhesive is a two-component adhesive (e.g., based on polyurethane and aromatic or aliphatic amines). Such two-component adhesives are well known in the art. Solvent based adhesive lamination may allow for longer chains and this will result in a stronger bonding of the laminate.

In some examples, the base layer and the contact layer are directly adhesive laminated meaning that no further layers are in between but the adhesive layer.

As an alternative to adhesive lamination, extrusion lamination can be used. The extrusion lamination may use a copolymer made of a material selected from a copolymer of ethylene and acrylic acid, ethylene and methacrylic acid and a terpolymer comprising ethylene, acrylic ester and a third polymer. The third polymer may be a glycidyl methacrylate a maleic anhydride, or alternatively the extrusion lamination may use poly(methyl methacrylate) (PMMA).

Extrusion lamination with PMMA may be particularly beneficial when the contact layer comprises or is PVDF. An example of a suitable PMMA is Plexiglas®HFI7. In some examples, the PMMA is pure.

In some examples, the base layer is laminated to at least a first outer layer. The first outer layer may include polyethyleneterephtalate (PET), polyethylene (PE), paper or a combination thereof.

Typically, the thickness of the contact layer or each of the monolayers of the contact layer is in the range of 20 to 60 μm while down to 15-20 μm is also contemplated.

In an example, the contact layer is polyamide and the side of the polyamide layer which is facing away from the base layer comprises amorphous polyamide. In some examples, the amorphous polyamide layer and the one or more crystalline polyamide layer(s) are co-extruded. In this example the contact layer is not a mono-layer.

In an example where the contact layer is PA, the contact layer is not corona treated on the amorphous PA side facing away from the base layer. In some examples, the side of the contact layer facing the base layer is corona treated prior to lamination.

By applying amorphous PA and/or not corona treating the side of the contact layer facing away from the base layer, i.e. the sealing side of the contact layer, the polyamide layer becomes weldable/sealable at lower temperatures starting at around 140 to 160° C. in contrast to commercially used PA's (such as PA6 or PA66 for example available from BASF) that require much higher temperatures, up 230° C.

Good sealing/welding is obtained when the amorphous PA layer constitutes about 10 to 40% of the thickness of the contact layer, since it is a balance to obtain a contact layer which is both sealable at lower temperatures while still facilitating a smooth production.

In other examples the contact layer is a monolayer comprising or consisting of COC. When the monolayer is a blend the COC content of the blend is at least 40% (w/w) of the monolayer.

In some examples where the contact layer is a COC layer it is corona treated, particularly the side of the layer facing the base layer. Typically, when the contact layer is or comprises COC the COC layer or each of the layers constituting the contact layer has a thickness of 18 to 22 μm. In some examples, the contact layer has a thickness of 20 μm.

In a further example the contact layer comprises or consists of COC co-extruded with a tie layer.

The tie layer may be low density poly ethylene (LDPE) in particular when the contact layer is COC.

In further examples, the contact layer is ethylene vinyl alcohol (EVOH). When the contact layer is EVOH, the layer or each of the layers constituting the contact layer typically has a thickness of 20 to 50 μm. In some examples, the contact layer has a thickness of 25 to 35 μm. In some examples, the contact layer has a thickness of 30 μm.

In further examples the contact layer comprises or is a cyclic block copolymer and the layer has a thickness of 20-60 μm.

In further examples the contact layer comprises or is a polyvinylidene fluoride and the layer has a thickness of 15-50 μm.

In further examples the contact layer comprises or is a cyclic olefin polymer and the layer has a thickness of 20-60 μm.

In further examples the contact layer comprises or is a high density polyethylene and the layer has a thickness of 15-60 μm.

In further examples the contact layer comprises or is an ethylene-methacrylic acid copolymer and the layer has a thickness of 15-50 μm.

In further examples the contact layer comprises or is a polyamide and the layer has a thickness of 15-60 μm.

In further examples the contact layer is cyclic block copolymer (CBC), a polyvinylidene fluoride (PVDF), a cyclic olefin polymer (COP), a high density polyethylene (HDPE) or an ethylene-methacrylic acid copolymer (EMAA).

It is contemplated that all the examples and variations to examples are usable in encapsulating an active ingredient, preferably an aggressive ingredient such lidocaine, amphetamine, testosterone, fentanyl, oxymorphone, tetrahydrocanabiol, rivastigmine, nicotine, diclofenac, dexibuprofen, ibuprofen, Dl-camphor, dextromethorphan, ondansetron, donepezil, methylphenidate, isopropyl myristate, i-methol, methyl salicylate, diphenhydramine, tolubuterol, buprenorphine, clonidine, scopolamine, preferred is fentanyl, nicotine, lidocaine or rivastigmine.

Hence, in further variations the laminate film or final laminate film encloses a composition and the laminate film is sealed/welded into a pouch, sachet or is used as a lidding film to a container.

Also provided is a laminate film, the film comprising at least a base layer, which is water and/or oxygen resistant, and a contact layer bound to the base layer, wherein the contact layer comprises or consists of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE) or an ethylene-methacrylic acid copolymer (EMAA). The contact layer may be adhesively bound to the base layer. It will be understood that the method used to bind the contact layer to the base layer may be adhesive lamination or extrusion lamination. The film may be produced according to the method outlined in the first aspect of the disclosure.

An aggressive chemical substance can be packed in the laminate film. The aggressive chemical substance can be any suitable substance. For example, it could be selected from lidocaine, amphetamine, testosterone, fentanyl, oxymorphone, tetrahydro-canabiol, rivastigmine, nicotine, diclofenac, dexibuprofen, ibuprofen, Dl-camphor, dextromethorphan, ondansetron, donepezil, methylphenidate, iso-propyl myristate, i-methol, methyl salicylate, diphenhydramine, tolubuterol, buprenorphine, clonidine, scopolamine, preferred are fentanyl, nicotine, lidocaine or rivastigmine.

Also provided is use of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), or a high density polyethylene (HDPE) or an ethylene-methacrylic acid copolymer (EMAA) in a contact layer of a film for packaging an aggressive chemical substance.

A second solution involves coextrusion. Thus, in a second aspect of the disclosure there is provided a method for providing a laminate film, said method including i) providing a base layer, which is water and/or oxygen resistant; ii) providing a contact layer; iii) coating the base layer with a coextrusion layer, said coextrusion layer comprising the contact layer and a tie layer; and iv) allowing the coextrusion layer and the base layer to adhere; wherein the contact layer comprises a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE), or an ethylene-methacrylic acid copolymer (EMAA).

In some examples, the tie layer has a) one layer and the loading of the one layer is at least 3 g/m2, or b) a plurality of layers and the loading of at least one layer of the plurality of layers is at least 3 g/m2, or the total loading of the plurality of layers is at least 3 g/m2.

It was found that the loading of the (individual) tie layer(s) has an effect on the sealing strength, the results presented in the application clearly show an increase in sealing strength following an increase in the loading of the contact layer part of the co-extrudate. However, it is also seen that when the loading of the tie layer gets too low, in the region of 3 g/m2 of a layer, there is a sudden drop in sealing strength also when more than one tie layer is present and the total loading of the plurality of tie layers is above 3 g/m2.

In some examples the contact layer consists of one substance which is a polymer selected from the group consisting of a cyclic olefin copolymer, a polyamide, an ethylene vinyl alcohol a cyclic block copolymer, a polyvinylidene fluoride, a cyclic olefin polymer, a high density polyethylene, or an ethylene-methacrylic acid copolymer and physical variations of thereof.

The contact layer may comprise or consist of a polymer selected from the group consisting of a cyclic block copolymer (CBC), a polyvinylidene fluoride (PVDF), a cyclic olefin polymer (COP), a high density polyethylene (HDPE), or an ethylene-methacrylic acid copolymer (EMAA).

The contact layer may have a loading of at least 5 g/m2. In some examples, the contact layer may have a loading of at least 10 g/m2.

In some examples, the tie layer is made of 1, 2, 3, 4 or 5 layers.

In some examples, all the layers of the tie layer are coextruded with the contact layer. The co-extrusion layer may be co-extrusion coated to the base layer.

In some examples the tie layer is constituted of one layer and the layer is a copolymer made of a material selected from a copolymer of ethylene and acrylic acid, ethylene and methacrylic acid and a terpolymer comprising ethylene, acrylic ester and a third polymer, which third polymer is preferably a glycidyl methacrylate, and more preferably a maleic anhydride.

In some examples the tie layer comprises at least two layers, wherein the first layer comprises a copolymer according to the above and the at least second or more layer(s) comprises a material selected from EEA, PE, EMA, EAA or a combination.

In some examples, the tie layer or at least one layer of a plurality of tie layers may comprise or consist of PMMA. An example of a suitable PMMA is Plexiglas® HFI7. Such tie layers may be particularly beneficial when the contact layer comprises or consists of PVDF, especially in extrusion coating. In some examples, the PMMA is pure.

In some examples the contact layer is polyamide and the side of the polyamide layer facing away from the base layer comprises amorphous polyamide.

In some examples, the layer, for example the polyamide layer, is amorphous. In alternative examples, a portion of the layer may be amorphous, for example 10 to 40% (w/w).

The laminate film may enclose a composition and the laminate film may be sealed into a pouch, sachet or used as a lidding film on a container.

In some examples, the method further comprises laminating at least a first outer layer to the base layer side of the laminate film.

The total the thickness of the laminate film may be in the range of 70 to 140 μm.

Also provided is a laminate film, the film comprising at least a base layer, which is water and/or oxygen resistant, and a coextrusion layer, wherein the coextrusion layer comprises a tie layer and a contact layer, wherein the contact layer comprises or consists of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE) or an ethylene-methacrylic acid copolymer (EMAA). The film may be obtained by the method outlined in the second aspect of the disclosure.

An aggressive chemical substance can be packed in the laminate film. The aggressive chemical substance can be any suitable substance. For example, it could be selected from lidocaine, amphetamine, testosterone, fentanyl, oxymorphone, tetrahydro-canabiol, rivastigmine, nicotine, diclofenac, dexibuprofen, ibuprofen, Dl-camphor, dextromethorphan, ondansetron, donepezil, methylphenidate, iso-propyl myristate, i-methol, methyl salicylate, diphenhydramine, tolubuterol, buprenorphine, clonidine, scopolamine, preferred is as fentanyl, nicotine, lidocaine or rivastigmine.

Also provided is use of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), or a high density polyethylene (HDPE) or an ethylene-methacrylic acid copolymer (EMAA) in a contact layer of a film for packaging an aggressive chemical substance.

### DETAILED DESCRIPTION

The term “film” or “laminate film” according to the disclosure contemplates a product comprising a base layer laminated, for example by adhesive lamination or extrusion lamination, co-extruded or co-extrusion coated to a contact layer. Further outer layers may be added such as PET and paper.

A “packaging” is in the context of the disclosure intended to mean a final laminate film used to pack a composition or compound or a container otherwise sealed with the films according to the disclosure.

The term “highly aggressive compound or composition” should be understood as a compound/composition which is reactive with metals, acids, bases, or functional groups such as ketones, alcohols, hydro carbons and/or esters, and/or, volatile but also easily migrates through barriers.

The term “oxygen and water resistant” as used in the context of the present disclosure contemplates material for which the oxygen transfer rate (OTR) and/or water vapor transfer rate (WVTR) is no more than 1. In some examples, the OTR and/or WVTR is no more than 0.1 as further detailed below. The term WVTR may also be referred to as the moisture vapor transfer rate (MVTR). WVTR and MVTR are equivalent.

The term “mechanically wear resistant layer” as used to describe the outer layer should be understood as a material which is suitable for the manufacture of a flexible packaging. The mechanically wear resistant layer may be chosen from but are not limited to materials such as polyethylene or polyamide based sheets, ortho-phthalaldehyde based sheets, or polyester based sheets or combinations. Further, the mechanically wear resistant material, i.e. the first outer layer, can be provided as a film that is biaxially oriented to give the packaging a higher mechanical strength, such as tear strength. The term “biaxial oriented” should be understood such that the provided polymer film has been stretched in both a longitudinal and a transverse direction during manufacturing.

The term “exterior side” should be understood in its broadest sense. The term exterior environment is used for defining the direction opposite of the side that is facing the composition or compound to be sealed by the laminate or packaging of the present disclosure. This means that the term exterior environment is independent on whether additional layers are coated, laminated or otherwise attached to the film. Thus, the word is used for specifying in which direction a side of a layer is facing.

According to all examples of the disclosure the base layer may be selected from but not limited to a metal foil, e.g., aluminum foil, a polymer selected from polyamide, polyvinylidene chloride, silicon or aluminium oxide coated polyesters, and/or fluro polymers, such as commercial Alu foil from e.g. Hydro, or AlOx coated PET films obtainable from e.g. Toray Films Europe, or SiOx coated PET films obtainable from e.g. Celplast under the tradename Ceramis®.

According to the disclosure water and/or oxygen resistance encompasses materials having an oxygen transfer rate (OTR) equal to or below 1 cm3/m2/24 hr/bar according to ASTM standard D3985 at 23° C. and 0% RH and/or water (or moisture) vapor transfer rate (WVTR) equal to or below 1 g/m2/24 hr according to ASTM standard F1249 at 38° C. and 90% RH. In some examples, both the WVTR and the OTR are below 0.01 g/m2/24 hr or 0.01 cm3/m2/24 hr/bar respectively.

According to the disclosure, the base layer of the film is selected to provide a number of properties to a laminate film and packaging comprising the laminate film. The base layer may give desired barrier and support properties to the final laminate/packaging. Furthermore, the base layer may be a gas and water impermeable base layer. In some examples, the base layer may be a water and/or oxygen resistant base layer.

In examples where the contact layer is hygroscopic, the base layer may be made of a metal foil, such as aluminum. Aluminum is price competitive, a superior barrier to all gases and moisture. Furthermore, similar to other metal-like materials, aluminum has good dead-fold properties, i.e. it does not unfold once folded, it reflects radiant heat, and gives a decorative appeal to laminates and packages.

Typically, the thickness of the base layer is 5-15 μm. In some examples, the base layer has a thickness between 7-12 μm. In some examples, the base layer has a thickness between 8-10 μm. In some examples, the base layer has a thickness of 9 μm, e.g., when the base layer comprises or consists of aluminium. Where the base layer comprises or consists of a polymer, for example PET, the thickness may be higher, for example in the range of 1-50 μm.

According to the disclosure the contact layer must be chemically resistant/inert to the API, such as a so-called aggressive substance and excipient, if present, ultimately to be packaged. Further, the contact layer must show a low absorption of the substances migrating through the film or laminate. The allowed degree of absorption for a given substance is typically dictated by the manufacturer of the substance but often the accepted values lie in the range of 0 to 1% (w/w). For some products up to 10% (w/w) is acceptable typically for products with a low initial API content. The absorption is calculated as the weight of API in a packaging after storage at the set duration for a particular product relative to the initial weight of the API in the commercial product. A typical shelf life is around 2 years, such as 18 months to 5 years.

It will be understood that the parameter by which the contact layer thickness is reflected depends on the method by which the laminate is formed, as is customary in the field. Thus, for laminates formed by lamination, for example adhesive lamination or extrusion lamination, the parameter used to reflect the contact layer thickness is μm. For laminates in which at least one tie layer and the contact layer are coextruded, the parameter used to define the contact layer and tie layer is the loading, which has unit g/m2. The skilled person will be able determine the thickness of each layer from the loading and the density of the material used, if necessary.

The contact layer may include a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE), or an ethylene-methacrylic acid copolymer (EMAA).

It is also envisaged that the contact layer is a blend of one of the polymers as defined hereinabove in combination with a lower grade polymer such as polyethylene (PE), polyethylene blends, or other polymers known to the skilled person. When in a blend, the contact layer may include at least 50% (w/w) of COC, PA, EVOH, CBC, PVDF, COP, HDPE, or EMAA.

When the film is adhesive laminated, it is also contemplated that the contact layer may comprise two or more layers including one or more tie layers. In such examples the side of the contact layer facing away from the base layer may be denoted seal layer and the side of the contact later facing the base layer is denoted tie layer. When consisting of two or more layers constituting the contact and/or tie layer, these layers may be prepared by suitable methods, such as co-extrusion.

According to all examples of the disclosure the contact layer may be made of a material selected from cyclic olefin copolymer, a polyamide, an ethylene vinyl alcohol, a cyclic block copolymer, a polyvinylidene fluoride, a cyclic olefin polymer, a high density polyethylene, or an ethylene-methacrylic acid copolymer (EMAA) or mixtures thereof, such as the commercial products EVAL® C109B sold by Kuraray, Selar PA 3426 R sold by Dupont® or COC 6013M-07, COC 8007F-600, 7010E-600 or 9506F500 sold by Topas® or EVOH obtainable from Nippon Gohsei under the tradename Soarnol®, COC films may be provided by Amcor or Plastique Venthenat. Other examples include ViviOn 8210 sold by USI corporation (CBC), Kynar® 710 sold by Zeus Industrial Products (PVDF), ZEONOR® 1420R sold by Zeon Specialty Materials, Inc. (COP), CG9620 or CG8410 sold by Borealis AG (HDPE) and Surlyn® sold by Dupont® (EMAA). Other variations of the same functionalities are within the scope of the disclosure.

In table 1 is listed non-exclusive examples of commercially available polymers that may be used as the contact layer according to the disclosure.

TABLE 1
Examples of commercial products of polymers usable
as contact layer according to the disclosure.

| Name | Abbreviation used | Trademark name |
|---|---|---|
| Cyclic olefin copolymer | COC | Topas ® 8007F-600 |
| Cyclic olefin copolymer | COC | Topas ® 9506F-500 |
| Cyclic olefin copolymer | COC | Topas ® 7010F-600 |
| Polyamide | PA | Selar ® PA 3426R |
| EVOH | EVOH | EVAL ™ EF-E #30 |
| Cyclic block copolymer | CBC | ViviOn ™ 8210 |
| Polyvinylidene fluoride | PVDF | Kynar ® 710 |
| Cyclic olefin polymer | COP | ZEONOR ® 1420R |
| High density polyethylene | HDPE | Borealis ® CG9620 |
| Ethylene-methacrylic acid | EMAA | Surlyn ® |
| copolymer | | |

In some examples, the contact layer consists of only one material, i.e. the contact layer is a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE), or an ethylene-methacrylic acid copolymer (EMAA). In some examples, the contact layer is a monolayer. In some examples, the contact layer is a monolayer of one material. Despite the challenges with providing a single component contact layer this may be preferential to avoid scalping since blends including PE may become permeated and thus result in a sieve like layer over time.

It has been found that when the contact layer comprises any of the polymers from the group above, even having a relatively low RED value, a chemical resistant film and laminate may be obtained even though the mentioned polymers chemically represent different polymer types. Tests have shown that the resistance of laminates in which the laminate film comprises the preferred polymers show results similar to or better than those of laminates coated/laminated with e.g. the commercial product Barex®. The RED value or the HSP parameter is a parameter known to the skilled person and more details can be found i.a. in Hansen, C., M., Hansen Solubility Parameters a User's Handbook 2nd Ed., CRC Press, Boca Raton, 2007.

EVOH is normally used in laminates due to the superior oxygen barrier properties of EVOH and tear strength. Despite being known to be very hydrophilic and hygroscopic (i.e. has a high WVTR) EVOH is very suitable as a contact layer according to the disclosure.

Also, polyamide (PA) has typically been used in laminates due to the superior mechanical properties like tear strength or as a barrier. As for EVOH, it is noteworthy that PA may be used as a contact layer for providing a chemical resistant laminate film despite the hydrophilic nature of PA.

Because of the hydrophilic nature of PA and EVOH, the laminate film obtained according to the disclosure may be tightly packed in a moisture barrier, in particular if it has to be stored. The laminate film according to the disclosure may be packed immediately after manufacture and should be kept safely packed until further use, for example in a packing line.

In some examples the contact layer is made from a blend of at least two polymers. Using blends can be a means for reducing the costs and for adapting the physical and chemical properties of the lamination process, such as reducing or increasing the melting temperature to comply with the profile of layers of a tie layer if present and the polarity of the blend to improve the adhesion properties of the layers and hence the robustness of the final product.

In one variation the cyclic olefin copolymer, a polyamide, an ethylene vinyl alcohol, a cyclic block copolymer, a polyvinylidene fluoride, a cyclic olefin polymer, a high density polyethylene, or an ethylene-methacrylic acid copolymer (EMAA) makes up at least 50% w/w of the blend of the contact layer, at least 60% w/w, at least 80% w/w, or at least 95% w/w of the contact layer or each layer of the contact layer. In this variation the contact layer is either a monolayer or comprised of two or more layers.

The tie layer may be selected from: ethylene methacrylic acid (EMAA), ethylene acrylic acid (EAA), e.g., an ethylene acrylic acid having an acrylic acid content of minimum 10% (W/W) based on the total weight of the ethylene acrylic acid layer (EEA-high acid), a terpolymer of ethylene, methacrylic acid and glycidyl methacrylate, terpolymer of ethylene, acrylic ester and maleic anhydride, preferably ethylene, butyl acrylate, and maleic anhydride (t-EBAMA), acrylic ester and maleic anhydride, preferably ethylene butyl acrylate, maleic anhydride (t-EBAMA), ethylene methyl acrylate (EMA), ethylene butyl acrylate (EBA), ethylene ethyl acrylate (EEA), low density poly ethylene (LDPE), a metallocene compound or, a combination thereof.

In some examples, the laminates according to the disclosure further comprise a first outer layer, suitably made from a material selected from but not limited to paper, polyethylene or polyamide based sheets, ortho-phthalaldehyde based sheets, or polyester based sheets, or combinations, such as the commercial product F-PAP sold by Flexpet. In some examples, the first outer layer is a combination of materials when polyester based sheets are used.

In some examples, the first outer layer and the laminate film are laminated to provide a packaging. Laminating the first outer layer to the laminate film provides a strong laminate when tested on several parameters, the packaging is easy to wrap and seal/weld.

In some examples, the laminate film further comprises a second outer layer facing the exterior side of the first outer layer. In some examples, the second outer layer is a paper layer. The paper layer is typically printed with the name, color and/or logo of the product and manufacturer of the product. It is also or alternatively contemplated that the first outer layer can be printed. In some examples where the first outer layer is polyethylene, the laminate film further comprises a second outer layer.

It is contemplated that an adhesive and/or polymer agent may be applied between the various layers. The adhesive and/or polymer agent used between the first outer layer and the base layer or the second outer layer may be made of the same or a different material as the adhesive used for the adhesive lamination of the base layer and the contact layer. Further, the agent applied between these layers may be selected from the two-component adhesive, extrusion laminated using a polymer selected from the group of materials used as tie layer according to the disclosure or a water based glue, the latter in particular when using a paper layer

Further suitable adhesives are adhesives approved for use in packaging products for human use and are well known to the skilled person. A suitable adhesive may be selected from but is not limited to polyurethane based adhesives, epoxy based adhesives, or acryl based adhesives, well known to the skilled person.

According to all aspects and examples of the disclosure utilising adhesive lamination, the adhesive used for the adhesive lamination is a two component adhesive commonly known in the art. Thus, it is based on polyurethane and epoxy, such as polyurethane and aromatic or aliphatic amines. An exemplary commercial polyurethane adhesive usable according to the disclosure is LOCTITE LIOFOL LA 3644-21 MHS/LA 6055 obtainable from Loctite® or Adcote™ 811A EA/MOR-FREE™ 200C co-reactant obtainable from Dow.

When the adhesive lamination is solvent based, a solvent may be selected from: ethyl acetate, acetone and methyl ethyl ketone or other solvents well known to the skilled person.

In use, the solvent and the two-component adhesive are mixed in a specific ratio in a usual manner as specified by the manufacturer. The base and hardener is mixed in a ratio recommended by the adhesive supplier—typically 8:1 to 15:1 calculated on solid content, but other ratios are contemplated.

The solvent is added to provide a viscosity in the range of 15 to 22 sec, such as around 17-18 sec as measured by DIN CUP 4 a method well known to the skilled person under the DIN 53211 standard.

Conveniently, most polymers, adhesives and other components usable in the method are conventional and thereby easily accessible from various suppliers thereby providing a cost efficient production.

The method may also include a) optionally providing a first and/or second outer layer; b) providing a laminate film according to the disclosure; c) placing a composition comprising a compound on the contact layer side of the laminate film; and d) sealing the outer layer and/or the laminate film, e.g., by heat sealing, in such a way to provide a hollow interior space for sealing the composition, said hollow space having an interior side and an exterior side, wherein the interior side of the film is the contact layer of the adhesive lamination layer and the exterior side of the film is the base layer and/or the first and second outer layers.

It is contemplated that a first and/or second outer layer is laminated to the laminate film before the operations of c) and d) for example in one combined laminating operation.

In general, the order in which the different layers of the packaging according to the disclosure are applied to the base layer is flexible. Hence, the first outer layer may be applied before the adhesive lamination and the other way around. The order depends on which production line is suitable in a specific situation.

Further, according to the disclosure, laminate films and packaging prepared according to the method are obtained by the disclosure.

According to the disclosure a laminate film according to the disclosure has various applications. In an example of the disclosure, the laminate film is used to wrap a composition comprising a compound selected from nicotine, fentanyl, lidocaine and rivastigmine. In some examples, the compound is formulated as a patch, such as a transdermal patch.

According to the disclosure, when the composition is a patch, the amount of the active ingredient remaining after storage for at least 7 days at 40° C. is a maximum+/−10% (w/w) as compared to the same active ingredient sealed in a similar Barex® patch as index 100.

According to the disclosure, the obtained laminate film is heat sealable or weldable. A heat sealable laminate film is capable of sealing to itself during heat sealing without creating any deformation. Deformation is undesirable in relation to quality assurance, where any deformation must be noted and explained, which is highly labor intensive. Furthermore, the legislation in many countries is very strict. Hence, films and/or laminates with any deformation are not allowed for packing active ingredients. Therefore, the mechanical properties are very important from a production cost efficiency perspective. Similarly, it is important that the laminates are tight.

The laminate film obtained in the present disclosure must be inert and impermeable to the compound which the laminate is enclosing. Hence, in an example of the disclosure a maximum of 10% (w/w), a maximum of 5% (w/w), a maximum of 1.5% (w/w), or a maximum 0.5% (w/w) of the compound has migrated into the laminate film after 12 weeks of storage at 40° C.

Laminate films of the disclosure may enclose a composition or compound comprising an active ingredient selected from the group consisting of nicotine, rivastigmine, fentanyl and lidocaine. These active ingredients are known as aggressive chemicals/compounds and require specialized packaging.

A packaging should comply with International standards such as 16 CFR § 1700.20 (for USA) and ISO 8317 (2003) corresponding to DIN EN ISO 8317 (2004) (for Europe). A “packaging” is in the context of the disclosure intended to mean a complete laminate film optionally including first and/or second outer layers used to pack a chemical compound.

The sealing of the packaging is achieved in such a way that the contact layer of the laminate film is facing the compound or composition so that the remaining part of the packaging is protected by the contact layer. In this way, the compound or composition is held within the interior of the packaging and will therefore only have direct contact with the contact layer of the layer of the laminate film.

The following are specific non-limiting examples of the disclosure that have shown good properties.

### Adhesive Lamination Examples:

Laminate films with COC as contact layer:
1) Paper/Adhesive/Aluminum/Adhesive/COC
2) PET/Adhesive/Aluminum/Adhesive/COC
3) Paper/Adhesive/Aluminum/Adhesive/oPA/Adhesive/COC
4) Paper/Adhesive 3 g/PET 23 μm/Adhesive 3 g/Aluminum/Adhesive/COC

And more specifically:
1) Paper 50 gsm/Adhesive 3 g/Aluminum 9 μm/Adhesive 3 g/COC 20 μm
2) PET 36 μm/Adhesive 3 g/Aluminum 9 μm/Adhesive 3 g/COC 20 μm
3) Paper 40 gsm/Adhesive 3 g/Aluminum 9 μm/Adhesive 3 g/oPA 15 μm/Adhesive 3 g/COC 20 μm
4) Paper 40 gsm/Adhesive 3 g/PET 23 μm/Adhesive 3 g/Aluminum 9 μm/Adhesive 3 g/COC 20 μm

Laminate films with PA as contact layer:
1) Paper/Adhesive/Aluminum/Adhesive/PA
2) PET/Adhesive/Aluminum/Adhesive/PA
3) Paper/Adhesive/Aluminum/Adhesive/oPA/Adhesive/PA
4) Paper/Adhesive/PET/Adhesive/Aluminum/Adhesive/PA.

And more specifically
1) Paper 50 gsm/Adhesive 3 g/Aluminum 9 μm/Adhesive 3 g/PA 40 μm
2) PET 23 μm/Adhesive 3 g/Aluminum 9 μm/Adhesive 3 g/PA 40 μm
3) Paper 40 gsm/Adhesive 3 g/Aluminum 9 μm/Adhesive 3 g/oPA 15 μm/Adhesive 3 g/PA 40 μm
4) Paper 40 gsm/Adhesive 3 g/PET 23 μm/Adhesive 3 g/Aluminum 9 μm/Adhesive 3 g/PA 40 μm

Specific laminate films with EVOH as contact layer:
1) PET/PE/Aluminum/Adhesive/EVOH
2) Paper/Adhesive/Aluminum/Adhesive/EVOH
3) PET/Adhesive/Aluminum/Adhesive/EVOH
4) Paper/Adhesive/Aluminum/Adhesive/oPA/Adhesive/EVOH
5) Paper/Adhesive/PET/Adhesive/Aluminum/Adhesive/EVOH

And more specifically:
1) PET 50 μm/PE 14g/Aluminum 9 μm/Adhesive 3 g/EVOH 30 μm
2) Paper 50 gsm/Adhesive 3 g/Aluminum 9 μm/Adhesive 3 g/EVOH 30 μm
3) PET 36 μm/Adhesive 3 g/Aluminum 9 μm/Adhesive 3 g/EVOH 30 μm
4) Paper 40 gsm/Adhesive 3 g/Aluminum 9 μm/Adhesive 3 g/oPA 15 μm/Adhesive 3 g/EVOH 30 μm
5) Paper 40 gsm/Adhesive 3 g/PET 23 μm/Adhesive 3 g/Aluminum 9 μm/Adhesive 3 g/EVOH 30 μm

### Example 1: Strength of Adhesive Lamination Examples

The disclosure will now be illustrated in more details with reference to the following non limiting examples in which the seal strength of laminate film illustrative of the disclosure are tested. In all examples seal strength was measured using the DIN55529 standard.

Laminate film with 100% COC as a mono contact layer comprising: PET 23 μm/adhesive/al 9 μm/adhesive/COC 20 μm produced by adhesive lamination using a two component solvent urethane based adhesive.

The laminate film was sealed for 0.5 sec at 0.5 N/mm2. The seal strength obtained in the temperature range of 120 to 190° C. was 10 to 15 N/15 mm. This strength equals a similar Barex® laminate having a 20 to 25 micron Barex® layer instead of COC.

Film with 100% cast PA as a mono contact layer comprising: PET 23 μm/adhesive/al 9 μm/adhesive/CPA 40 μm produced by adhesive lamination using a two component solvent urethane based adhesive.

The laminate film was sealed for 0.5 sec at 0.5 N/mm2. The seal strength obtained in the temperature range of 150 to 200° C. was 25 to 40 N/15 mm. This strength equals a similar Barex® laminate having a 50 micron Barex® layer, meaning that a laminate with PA as contact/sealing layer offers higher seal strength than Barex® even with a lower film thickness of the contact/seal layer.

Film with 100% EVOH as a mono contact layer comprising: PET 50 μm/PE 12 gsm/al 9 μm/adhesive/EVOH 30 μm produced by adhesive lamination using a two component solvent urethane based adhesive.

The laminate film was sealed for 0.5 sec at 0.5 N/mm2. The seal strength obtained in the temperature range of 150 to 200° C. was 25 to 40 N/15 mm. This strength equals that of a similar Barex® laminate having a 50 micron Barex® layer. Thus the EVOH film offered the same seal strength albeit with a lower film thickness of the seal layer also meaning that a higher seal strength than for Barex® can be obtained if so desired.

### Example 2: RED & CHI Values

Tests were conducted to determine the RED and CHI values for PVDF, HDPE and EMAA samples for a range of chemical species.

RED Calculation

Determination of the HSP values and interaction radius requires that the solubility of the drug is evaluated against at least 16 solvents having a range of polar and hydrogen bonding properties. The methodology of determining HSP values, interaction radius and RED values is described in C. M. Hansen: “Hansen Solubility Parameters, A User's Handbook”, CRC Press, 2007, Second Edition and exemplified in EP 2 895 531.

For assessing solubility, first each sample was weighed in a standard test tube and an aliquot of the screening solvent was added. The test tubes were then placed on a rolling bench for 24 hours and visually checked to see whether or not the samples had dissolved/swollen.

When a sample is soluble, score 1 is given; when a sample is swollen, score 2 is given; when the sample is not soluble, score 3 is given.

If the solubility is plotted in Hansen space (3-dimensional: δD=dispersion parameter/δP=polar parameter/δH=hydrogen bonding parameter), where 1=soluble, 2=swollen and 3=not dissolved, the solubility domain can be calculated using a fitting algorithm. The relevant parameters for PVDF, HDPE and EMAA are summarised in Table 2 and the results of the tests shown in table 3.

TABLE 2
δD, δP, δH, R, Fit values for PVDF, HDPE and EMAA samples

| Polymer | δD | δP | δH | R | Fit |
|---|---|---|---|---|---|
| PVDF - Kynar | 15.77 | 10.46 | 13.88 | 5.7 | 0.948 |
| 710 | | | | | |
| HDPE - CG9620 | 19.88 | 11.07 | 4.43 | 2.7 | 0.983 |
| EMAA -Surlyn | 20.74 | 8.1 | 7.85 | 7.8 | 0.931 |
| 1652 | | | | | |

The RED and CHI values for the samples in relation to a range of chemical species are provided in Table 3.

TABLE 3
RED and CHI values for HDPE, PVDF and EMAA

| | HDPE- Kynar 710 | | PVDF- CG9620 | | EMAA- Surlyn 1652 | |
|---|---|---|---|---|---|---|
| API | RED | CHI | RED | CHI | RED | CHI |
| Lidocaine | 2.86 | 1.39 | 1.90 | 2.73 | 1.05 | 1.56 |
| Amphetamine | 3.17 | 1.05 | 2.04 | 1.95 | 0.96 | 0.81 |
| Testosterone | 2.40 | 1.12 | 1.89 | 3.12 | 0.68 | 0.76 |
| Menthol | 3.87 | 2.05 | 1.75 | 1.86 | 1.24 | 1.76 |
| Fentanyl | 2.26 | 1.19 | 2.24 | 5.20 | 0.85 | 1.38 |
| Oxymorphone | 2.58 | 1.07 | 1.84 | 2.42 | 0.39 | 0.20 |
| Tetrahydrocanabiol | 3.94 | 3.58 | 2.25 | 5.20 | 1.22 | 2.88 |
| Rivastigmine | 2.32 | 0.95 | 1.46 | 1.67 | 0.74 | 0.80 |
| Nicotine | 2.45 | 0.71 | 2.02 | 2.16 | 0.79 | 0.62 |
| Diclofenac | 2.70 | 1.14 | 1.95 | 2.64 | 0.34 | 0.15 |
| Dexibuprofen | 3.78 | 2.18 | 1.89 | 2.42 | 1.08 | 1.48 |
| Ibuprofen | 3.78 | 2.18 | 1.89 | 2.42 | 1.08 | 1.48 |
| Dl-Camphor | 2.97 | 1.02 | 2.33 | 2.80 | 1.19 | 1.36 |
| Dextromethorphan | 2.08 | 1.74 | 2.39 | 0.76 | 0.96 | 1.42 |
| Ondansetron | 0.95 | 0.17 | 2.29 | 4.33 | 0.58 | 0.51 |
| Donepezil | 1.41 | 0.48 | 1.97 | 4.11 | 0.54 | 0.57 |
| Methylphenidate | 3.11 | 1.54 | 2.08 | 3.09 | 0.99 | 1.30 |
| Isopropyl | 4.48 | 4.66 | 2.44 | 6.13 | 1.60 | 4.94 |
| Myristate | | | | | | |
| l-Methol | 3.87 | 2.05 | 1.75 | 1.86 | 1.24 | 1.76 |
| Methyl Salicylate | 2.47 | 0.58 | 1.25 | 0.66 | 0.61 | 0.29 |
| Diphenhydramine | 3.54 | 2.31 | 2.36 | 4.59 | 1.16 | 2.08 |
| Tolubuterol | 3.42 | 1.71 | 2.12 | 2.93 | 1.19 | 1.72 |
| Buprenorphine | 3.47 | 3.54 | 1.86 | 4.52 | 0.77 | 1.44 |
| Clondine | 1.32 | 0.20 | 1.94 | 1.94 | 0.32 | 0.10 |
| Scopolamine | 2.70 | 1.36 | 1.66 | 2.28 | 0.69 | 0.75 |

It will be understood that RED values reflect an experimental determination of R, whereas CHI represents a theoretical determination based on the volume of the API.

APIs for which both the RED and CHI are above 1 are believed to be very suitable for being packaged in a film faced by the contact layer, APIs where one of the RED and CHI (typically the CHI value) are below 1 are believed to be less suitable. APIs where both the RED and CHI are below 1 are believed to be even less suitable for being packaged in films having the subject contact layer.

As can be seen from both the experiment and theoretical calculation, the contact layers tested have a broad applicability as contact layer for APIs (values under 1 are in italics).

### Example 3: Strength of Coextrusion Examples

Mechanical properties were tested. Different laminate films were made all including an outer layer and a base layer to mimic a commercial product. The laminate films were produced with varying applications of co-extrudates as shown in Table 4.

All laminate films were made of PET23/AL9 with coextruded HDPE as follows:

Tie layer 2: Nucrel® 0609HSA (an ethylene methacrylic acid)

Tie layer 1: PE MI15 (a PE, e.g. Borealis® CA9150)

Contact layer: Borealis® CG9620 (an HDPE)

TABLE 4
Loading of coextrusion layer samples

| | | | Contact | Total | Total |
|---|---|---|---|---|---|
| | Tie layer | Tie layer | layer | application | application |
| Film | 2 loading | 1 loading | loading | (intended) | (actual) |
| # | (g/m²) | (g/m²) | (g/m²) | (g/m²) | (g/m²) |
| 1 | 1.6 | 1 | 7.4 | 10 | 8.6 |
| 2 | 3 | 3 | 8 | 14 | 13.9 |
| 3 | 4 | 4 | 8 | 16 | 14.5 |
| 4 | 7 | 7 | 12 | 26 | 24 |
| 5 | 3 | 3 | 14 | 20 | 17.3 |
| 6 | 4 | 4 | 18 | 26 | 25.8 |
| 7 | 4 | 4 | 22 | 30 | 28.5 |
| 8 | 4 | 4 | 24 | 32 | 28.1 |
| 9 | 8 | 8 | 40 | 56 | 52.6 |

As can be seen, there was a discrepancy between the target loading and the actual loading. It is thought that in practice the discrepancies lies in the tie layer loadings being lower than the target values.

### Methods:

The mechanical properties of the laminate films of table 4 were tested. In particular, the following properties were tested:
Tear strength
Puncture resistance (front side)
Sealing strength
Lamination strength
Exploration test

All tests were made according to industry standards and with some modifications as detailed below:

Tear strength—according to ASTM D1938-14 with no modifications.

Puncture resistance—according to ASTM F1306 with the following modifications: sample diameter 48 mm instead of 34.9 mm and puncture tool tip diameter 3.0 mm instead of 3.2 mm).

Sealing strength according to DIN 55529 with no modifications.

The sealing strength test was made under the following conditions: 160° C., 500N pressure, 0.5 seconds.

Lamination strength according to ASTM D903-98(2010) with the following modifications: Sample width was 15 mm instead of 25 mm, samples were not conditioned to 23° C.+/−1° C., 50% RH+/−2%. Instead all samples were kept at the same place and thus continuously kept under identical conditions. The pull speed was set to 100 mm/min instead of 305 mm/min. The measuring angle was 90° not 180°.

The exploration strength test was made as follows: a four-sided sealed bag was sealed with parameters 160° C., 0.5 seconds and 500 N pressure, with a size of 80 mm×90 mm including a 5 mm wide sealing area.

The bag was held and penetrated with a syringe connected to a pressure device. The bag was then inflated to a pressure of 0.2 bar in one test (Exploration test 1) and 0.25 bar in another test (Exploration test 2). The success criteria for a given laminate is to withhold the pressure for 30 seconds without bursting.

The results of all the tests made is given in table 5.

TABLE 5
Mechanical strength test results of samples identified in Table 4

| | | Tear | Tear | | | | | |
|---|---|---|---|---|---|---|---|---|
| | | Strength | Strength | Puncture | | | | |
| | Coating | (Machine | (Cross | resistance | Coexcoating | Sealing | | |
| | Loading | direction) | direction) | Front side | adhesion test | strength | Exploration | Explor. |
| No. | (g/m²) | (N) | (N) | (N) | (N/15 mm) | #1 (N/15 mm) | test 1 | test 2 |
| 1 | 8.6 | 1.6 | 1.7 | 41.3 | Tear | 7.3 | Fail | Fail |
| 2 | 13.9 | 1.6 | 1.6 | 42.4 | Tear | 11.5 | ok | Fail |
| 3 | 14.5 | 1.5 | 1.7 | 36.7 | Tear | 9..9 | ok | Fail |
| 4 | 24 | 2.5 | 2.6 | 43.4 | Tear | 13.6 | ok | Fail |
| 5 | 17.3 | 2.4 | 3.3 | 41.2 | Tear | 12.9 | Fail | Fail |
| 6 | 25.8 | 3.7 | 3.2 | 41.5 | Tear | 14.2 | ok | ok |
| 7 | 28.5 | 3.3 | 4.5 | 42.7 | Tear | 18.7 | ok | ok |
| 8 | 28.1 | 4.6 | 5.4 | 39.8 | Tear | 17.8 | ok | ok |
| 9 | 52.6 | 5.6 | 6.1 | 46.4 | Tear | 29.3 | ok | ok |

### Discussion

Tear strength levels range from 1.5 to 6.1 N. The results indicate that the main influence on tear strength is the thickness of the contact layer, rather than the thickness of the tie layers or total thickness of the coextrusion layer.

When looking at puncture resistance, samples 1 to 9 show puncture resistance from 36.7N to 46.4N (front side). This is only an increase of approximately 22 percent even though the coating weight increases as much as 4 times from the lowest loading to the highest. This indicates that the main influence on puncture resistances is the base material.

Lamination strength could not be measured since all samples tore when trying to separate the co-extrudate. This indicates that in all circumstances the adhesion level of the co-extrudate is larger than the tear strength of the co-extrudate.

Regarding sealing strength, the results clearly show an increase in sealing strength following an increase in the loading of the contact layer part of the co-extrudate. However, it is also seen that when the loading of the tie layers gets too low, in the region of 3 g/m2 per layer, there is a sudden drop in sealing strength. This is seen in sample 1 with a sealing strength of 7.3 N/15 mm and sample 5 with a sealing strength of 12.9 N/15 mm.

Sample 1 has a contact layer loading of 7.4 g/m2 which is almost the same as sample 2, but sample 2 has a significantly higher seal strength. Sample 5 has a contact layer loading of 14 g/m2 but has a sealing strength lower than sample 4 which has a contact layer loading of 12 g/m2. It is noted that the measured total loading of sample 5 was 17 g/m2, even though the target of the layer distribution was 20 g/m2, which indicates that the loading of the tie layers is, in reality, lower than 3 g/m2 which may explain the difference.

This is also confirmed in the exploration test in which samples 1 and 5 fail to withstand the internal pressure, indicating that tie layer loadings above 3 g/m2 is important, at least in some circumstances, to achieve the desired properties.

### Clauses

“A” clauses relate to adhesive lamination:

A1. A method for providing a laminate film, said method including i) providing a base layer, which is water and/or oxygen resistant; ii) providing a contact layer; and iii) laminating the base layer to the contact layer, e.g., by adhesive lamination or extrusion lamination; wherein the contact layer comprises a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE) or an ethylene-methacrylic acid copolymer (EMAA).

A2. A method according to clause A1, wherein the contact layer is a polymer selected from the group consisting of a cyclic olefin copolymer, a polyamide, an ethylene vinyl alcohol, a cyclic block copolymer (CBC), a polyvinylidene fluoride (PVDF), a cyclic olefin polymer (COP), a high density polyethylene (HDPE) or an ethylene-methacrylic acid copolymer (EMAA).

A3. A method according to clause A1 or A2, wherein the contact layer is a monolayer.

A4. A method according to anyone of clause A1 to A3, wherein the lamination is adhesive lamination and particularly is solvent based adhesive lamination.

A5. A method according to clause A4, wherein the adhesive used for the adhesive lamination is a two-component adhesive based on polyurethane and aromatic or aliphatic amines. In some examples, the solvent is ethyl acetate.

A6. A method according to any one of clauses A1 to A3, wherein the lamination is extrusion lamination.

A7. A method according to clause A6, wherein the extrusion lamination uses a copolymer made of a material selected from a copolymer of ethylene and acrylic acid, ethylene and methacrylic acid and a terpolymer comprising ethylene, acrylic ester and a third polymer In some examples, the third polymer is a glycidyl methacrylate. In some examples, the third polymer is a maleic anhydride. In some examples, the extrusion lamination uses PMMA.

A8. A method according to anyone of the previous clauses, wherein the base layer is laminated to at least a first outer layer. In some examples, the first outer layer comprises polyethyleneterephtalate (PET), polyethylene (PE), paper or a combination thereof.

A9. A method according to anyone of clauses A1 to A8, wherein the contact layer is polyamide and the side of the polyamide layer facing away from the base layer comprises amorphous polyamide.

A10. A method according to clause A9, wherein the amorphous polyamide layer and the polyamide layer(s) are co-extruded.

All. A method according to clause A8 or A9, wherein the side of the contact layer facing the base layer is corona treated.

A12. A method according to anyone of clauses A9 to A11, wherein the amorphous PA layer constitutes 10 to 40% of the thickness of the contact layer.

A13. A method according to anyone of the clauses A1 to A8, wherein the contact layer comprises or consists of COC.

A14. A method according to clause A13, wherein the contact layer comprises COC and wherein the COC content is at least 40% (w/w) or wherein the contact layer is a co-extrudate of COC and a tie layer.

A15. A method according to clause A13 or A14, wherein the COC layer is corona treated.

A16. A method according to any one of clause A13 to A15, wherein the COC layer has a thickness of 18 to 22 μm. In some examples, the COC layer has a thickness of 20 μm.

A17. A method according to anyone of the clauses A1 to A8, wherein the contact layer is ethylene vinyl alcohol and wherein the EVOH layer has a thickness of 25 to 35 μm. In some examples, the EVOH layer has a thickness of 30 μm.

A18. A method according to any one of clauses A1 to A8, wherein the contact layer comprises or is a cyclic block copolymer and wherein the layer has a thickness of 20-60 μm.

A19. A method according to any one of clauses A1 to A8, wherein the contact layer comprises or is a polyvinylidene fluoride and wherein the layer has a thickness of 15-50 μm.

A20. A method according to any one of clauses A1 to A8, wherein the contact layer comprises or is a cyclic olefin polymer and wherein the layer has a thickness of 20-60 μm.

A21. A method according to any one of clauses A1 to A8, wherein the contact layer comprises or is a high density polyethylene and wherein the layer has a thickness of 15-60 μm.

A22. A method according to any one of clauses A1 to A8, wherein the contact layer comprises or is an ethylene-methacrylic acid copolymer and wherein the layer has a thickness of 15-50 μm.

A23. A method according to any one of clauses A1 to A8, wherein the contact layer comprises or is a polyamide and wherein the layer has a thickness of 15-60 μm.

A24. A method according to anyone of the previous clauses, wherein the laminate film encloses a composition and the laminate film is sealed into a pouch, sachet or is used as a lidding film on a container.

A25. A method according to anyone of the previous clauses, wherein the method further includes laminating at least a first outer layer to the base layer side of the laminate film.

A26. A method according to anyone of the previous clauses, wherein the thickness of the laminate film is in the range of 70 to 140 μm.

A27. A laminate film, the film comprising at least a base layer, which is water and/or oxygen resistant, and a contact layer bound to the base layer, wherein the contact layer comprises or consists of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE) or an ethylene-methacrylic acid copolymer (EMAA).

A28. A laminate film according to clause A27, wherein the contact layer is adhesively bound to the base layer.

A29. A laminate film according to clause A27 obtained by the method of any one of clause A1 to A26.

A30. An aggressive chemical substance packed in a laminate film, wherein the laminate film is according any one of clause A27, A28 or A29.

A31. An aggressive chemical substance packed in a laminate film according to clause A30, wherein the aggressive chemical substance is selected from the group consisting of nicotine, fentanyl, lidocaine and rivastigmine.

A32. Use of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), or a high density polyethylene (HDPE) or an ethylene-methacrylic acid copolymer (EMAA) in a contact layer of a film for packaging an aggressive chemical substance.

“B” clauses relate to coextrusion:

B1. A method for providing a laminate film, said method including i) providing a base layer, which is water and/or oxygen resistant; ii) providing a contact layer; iii) coating the base layer with a coextrusion layer, said coextrusion layer comprising the contact layer and a tie layer; and iv) allowing the coextrusion layer and the base layer to adhere; wherein the contact layer comprises a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE), or an ethylene-methacrylic acid copolymer (EMAA).

B2. A method according to clause B1, wherein the tie layer has: one layer and the loading of the one layer is at least 3 g/m2, or b) a plurality of layers and the loading of at least one layer of the plurality of layers is at least 3 g/m2, or the total loading of the plurality of layers is at least 3 g/m2.

B3. A method according to clause B1 or B2, wherein the contact layer is a polymer selected from the group consisting of a cyclic olefin copolymer, a polyamide, an ethylene vinyl alcohol, a cyclic block copolymer (CBC), a polyvinylidene fluoride (PVDF), a cyclic olefin polymer (COP), a high density polyethylene (HDPE), or an ethylene-methacrylic acid copolymer (EMAA).

B4. A method according to any one of clause B1 to B3, wherein the contact layer is a cyclic block copolymer (CBC), a polyvinylidene fluoride (PVDF), a cyclic olefin polymer (COP), a high density polyethylene (HDPE), or an ethylene-methacrylic acid copolymer (EMAA).

B5. A method according to any one of clause B1 to B4, wherein the contact layer has a loading of at least 5 g/m2. In some examples, the contact layer has a loading of at least 10 g/m2.

B6. A method according to any one of clause B1 to B4, wherein the tie layer is made of 1, 2, 3, 4 or 5 layers.

B7. A method according to clause B6, wherein all the layers of the tie layer are coextruded with the contact layer.

B8. A method according any one of clause B1 to B7 wherein the co-extrusion layer is co-extrusion coated to the base layer.

B9. A method according any one of the preceding clauses, wherein the tie layer is constituted of one layer and wherein the layer is a copolymer made of a material selected from a copolymer of ethylene and acrylic acid, ethylene and methacrylic acid and a terpolymer comprising ethylene, acrylic ester and a third polymer. In some examples, the third polymer is a glycidyl methacrylate. In some examples, the third polymer is a maleic anhydride.

B10. A method according to any one of the clause B1 to B8, wherein the tie layer comprises at least two layers, and wherein the first layer comprises a copolymer according to clause B8 and the at least second or more layer(s) comprises a material selected from EEA, PE, EMA, EAA or a combination.

B11. A method according to any preceding clause, wherein the contact layer is polyamide and the side of the polyamide layer facing away from the base layer comprises amorphous polyamide.

B12. A method according to any one of the previous clauses, wherein the laminate film encloses a composition and the laminate film is sealed into a pouch, sachet or is used as a lidding film on a container.

B13. A method according to any one of the previous clauses, wherein the method further includes laminating at least a first outer layer to the base layer side of the laminate film.

B14. A method according to any one of the previous clauses, wherein total the thickness of the laminate film is in the range of 70 to 140 μm.

B15. A laminate film, the film comprising at least a base layer, which is water and/or oxygen resistant, and a coextrusion layer, wherein the coextrusion layer comprises a tie layer and a contact layer, wherein the contact layer comprises or consists of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE) or an ethylene-methacrylic acid copolymer (EMAA).

B16. A laminate film according to clause B15 obtained by the method of any one of clauses B1 to B14.

B17. An aggressive chemical substance packed in a laminate film, wherein the laminate film is according to any one of clauses B15 or B16.

B18. An aggressive chemical substance packed in a laminate film according to clause B17, wherein the aggressive chemical substance is selected from the group consisting of nicotine, fentanyl, lidocaine and rivastigmine.

B19. Use of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), or a high density polyethylene (HDPE) or an ethylene-methacrylic acid copolymer (EMAA) in a contact layer of a film for packaging an aggressive chemical substance.

B20. Use according to clause B19, comprising a base layer, a tie layer and a contact layer and wherein the contact layer and tie layer are co-extrusion coated to the base layer.

1. A method for providing a laminate film, comprising:
providing a base layer, wherein the base layer is water resistant, oxygen resistant, or both;
providing a contact layer; and
laminating the base layer to the contact layer, wherein the base layer is laminated by an adhesive lamination or an extrusion lamination;
wherein the contact layer comprises a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE), or an ethylene-methacrylic acid copolymer (EMAA).

2. The method of claim 1, wherein the contact layer is a polymer selected from the group consisting of a cyclic olefin copolymer, a polyamide, an ethylene vinyl alcohol, a cyclic block copolymer (CBC), a polyvinylidene fluoride (PVDF), a cyclic olefin polymer (COP), a high density polyethylene (HDPE) or an ethylene-methacrylic acid copolymer (EMAA).

3. The method of claim 1, wherein the contact layer is a monolayer.

4. The method of claim 1, wherein the lamination is adhesive lamination, and wherein the adhesive lamination is a solvent-based adhesive lamination.

5. The method of claim 4, wherein the adhesive used for the adhesive lamination is a two-component adhesive based on polyurethane and aromatic or aliphatic amines, and wherein a solvent for the adhesive lamination is ethyl acetate.

6. The method of claim 1, wherein the lamination is extrusion lamination.

7. The method of claim 6, wherein:
the extrusion lamination uses a copolymer made of a material selected from a copolymer of ethylene and acrylic acid, ethylene and methacrylic acid and a terpolymer comprising ethylene, acrylic ester and a third polymer, wherein the third polymer is a maleic anhydride, or
the extrusion lamination uses poly(methyl methacrylate) (PMMA).

8. The method of claim 1, wherein the base layer is laminated to at least a first outer layer, wherein the first outer layer comprises polyethyleneterephtalate (PET), polyethylene (PE), paper, or a combination thereof.

9. The method of claim 1, wherein the contact layer is polyamide and a side of the polyamide layer facing away from the base layer comprises amorphous polyamide.

10. The method of claim 9, wherein the amorphous polyamide layer and the polyamide layer are co-extruded.

11. The method of claim 8, wherein a side of the contact layer facing the base layer is corona treated.

12. The method of claim 9, wherein the amorphous polyamide layer constitutes 10% to 40% of a thickness of the contact layer.

13. The method according to claim 1, wherein the contact layer comprises or consists of COC.

14. The method of claim 13, wherein:
the contact layer comprises COC and wherein a COC content of the contact layer is at least 40% (w/w), or
the contact layer is a co-extrudate of COC and a tie layer.

15. The method of claim 13, wherein a side of the COC layer facing the base layer is corona treated.

16. The method of claim 13, wherein the COC layer has a thickness of 18 to 22 μm.

17. The method of claim 1, wherein the contact layer comprises or is ethylene vinyl alcohol and wherein the contact layer has a thickness of 25 to 35 μm.

18. The method of claim 1, wherein the contact layer comprises or is a cyclic block copolymer and wherein the contact layer has a thickness of 20 μm-60 μm.

19. The method of claim 1, wherein the contact layer comprises or is a polyvinylidene fluoride and wherein the contact layer has a thickness of 15 μm-50 μm.

20. The method of claim 1, wherein the contact layer comprises or is a cyclic olefin polymer and wherein the contact layer has a thickness of 20 μm-60 μm.

21. The method of claim 1, wherein the contact layer comprises or is a high density polyethylene and wherein the contact layer has a thickness of 15 μm-60 μm.

22. The method of claim 1, wherein the contact layer comprises or is an ethylene-methacrylic acid copolymer and wherein the contact layer has a thickness of 15 μm-50 μm.

23. The method of claim 1, wherein the contact layer comprises or is a polyamide and wherein the contact layer has a thickness of 15 μm-60 μm.

24. The method of claim 1, wherein the laminate film encloses a composition and the laminate film is sealed into a pouch, sachet, or is used as a lidding film on a container.

25. The method of claim 1, further comprising:
laminating at least a first outer layer to a base layer side of the laminate film.

26. The method of claim 1, wherein a thickness of the laminate film is in a range of 70 μm to 140 μm.

27. A laminate film, comprising:
at least a base layer, wherein the base layer is water resistant, oxygen resistant, or both, and
a contact layer bound to the base layer, wherein the contact layer comprises or consists of a polymer selected from the group consisting of a cyclic olefin copolymer (COC), a polyamide (PA), an ethylene vinyl alcohol (EVOH), a cyclic block copolymer (CBC), a polyvinylidene fluoride (PVDF), a cyclic olefin polymer (COP), a high density polyethylene (HDPE) or an ethylene-methacrylic acid copolymer (EMAA).

28. The laminate film of claim 27, wherein the contact layer is adhesively bound to the base layer.

29. (canceled)

30. The laminate film of claim 27, wherein an aggressive chemical substance is packed in the laminate film.

31. The laminate film of claim 30, wherein the aggressive chemical substance is selected from the group consisting of nicotine, fentanyl, lidocaine and rivastigmine.

32. (canceled)
